(19) United States
(12) Patent Application Publication
(10) Pub. No.: US 2013/0322222 A1
(43) Pub. Date: Dec. 5, 2013

(54) OPTICAL INFORMATION RECORDING MEDIUM AND REPRODUCING APPARATUS

(71) Applicant: Sony Corporation, Tokyo (JP)

(72) Inventors: Toshihiro Horigome, Kanagawa (JP); Satoru Higashino, Tokyo (JP); Hideki Ando, Tokyo (JP)

(73) Assignee: Sony Corporation, Tokyo (JP)

(21) Appl. No.: 13/899,603

(22) Filed: May 22, 2013

(30) Foreign Application Priority Data
Jun. 4, 2012 (JP) 2012-126724

(51) Int. Cl. G11B 7/007

(52) U.S. Cl. CPC G11B 7/00718
USPC 369/47.1

(57) ABSTRACT

An optical information recording medium on which recording address information is performed by a CAV or a zone CAV system, wherein a groove wobbling continuously is formed in advance to record the information to the groove and a land abutting the groove, the address information is recorded by a wobble where a plurality of modulated waves modulated by the address information are multiply formed, the modulated wave is a higher harmonic wave whose frequency is a fundamental wave of the fundamental frequency of the wobble, or an integer times the fundamental frequency of the wobble, one modulated wave is modulated by the address information of one land of the abutting lands which interpose the groove, and the other modulated wave is modulated by the address information of the other land of the abutting lands which interpose the groove.

### BACKGROUND

The present technology relates to an optical information recording medium and a reproducing apparatus.

In the past, an optical disc which records information or reproduces recording information by using a laser beam was applied practically. As for a kind of optical disc, there are a read only type, write once type, and rewriting type. In the write once type and the rewriting type, it is necessary that address information which indicates a position of the optical disc in advance is recorded for recording the information.

As for the method of recording address information, there are two kinds. One of them is a method that records the address information with a preformatted pit. Other method is a method that modulates a signal which forms a ditch referred to as a wobble to the ditch by the address information. Recording the preformatted pit has a problem that an area for recording user data is reduced, and a recording capacity is reduced. A wobble method has an advantage that such a problem does not occur. Further, the ditch is referred to as a groove, and a track formed by the groove is referred to as a groove track. The groove, in a time of manufacturing the optical disc, is defined as a portion which is irradiated by the laser beam, an area which is interposed between abutting grooves is referred to as a land, and a track which is formed by the land is referred to as a land track.

In the case of recording the address by the wobble, for further increasing the recording capacity, it is desirable to use the method of recording data to both sides of the groove track and the land track (appropriately referred to as a land-groove recording method). In the land-groove recording method, it is possible to record the address information corresponding to the groove track by causing the laser beam to be biased in a time of cutting. However, it is difficult to record the address corresponding to the land track by the wobble. In a case of scanning the land track, the wobble of groove tracks of the both sides is reproduced. However, the wobble is information of different groove track, and, in a state that the wobble is not in phase, it is difficult to reproduce the wobble.

From the past, in the land-groove recording method, an optical disc which enables to reproduce the address of the both sides of the groove track and the land track has been suggested. Japanese Unexamined Patent Application Publication No. 9-219024 discloses that the address is intermittently recorded in a case of recording the address to the groove track by the wobble, and further, the phase of recording position of the address is reversed between the groove track and an abutting groove track. Thus, in a time of reproducing the wobble track, the address information which was recorded originally is intermittently reproduced, and, when the land track is reproduced, the address of abutting groove tracks of both sides becomes to be reproduced alternately. As a result, in any one of the time of scanning the groove and the time of scanning the land, it is possible to obtain wobble information (address information).

Japanese Unexamined Patent Application Publication No. 2003-178464 and Japanese Unexamined Patent Application Publication No. 2006-228293 disclose that each of the land track and the groove track is made wobble, and the address information is recorded on a side wall of one side of each track by the wobble. Further, an address information block of the wobble track and an address information block of the groove track are shifted and arranged in the direction of the track.

### SUMMARY

In a case of adopting a groove land recording method, in the past method of recording and reproducing the address information by the wobble, when a reproducing laser spot is positioned at a land portion, an address signal recorded by the wobbles of both abutting grooves has been mixed thereto. Thus, it is difficult to reproduce the address information correctly.

It is desirable to provide an optical information recording medium and a reproducing apparatus that are capable of restoring the address information in a time of reproducing the land as well as in a time of reproducing the grove.

According to an embodiment of the present technology, there is provided an optical information recording medium on which recording address information is performed by a CAV or a zone CAV system, wherein a groove wobbling continuously is formed in advance to record the information to the groove and a land abutting the groove, wherein the address information is recorded by a wobble where a plurality of modulated waves which have been modulated by the address information are multiply formed, wherein the modulated wave is a higher harmonic wave whose frequency is a fundamental wave of the fundamental frequency of the wobble, or an integer times the fundamental frequency of the wobble, wherein one modulated wave is modulated by the address information of one land of the abutting lands which interpose the groove, and wherein the other modulated wave is modulated by the address information of the other land of the abutting lands which interpose the groove.

According to another embodiment of the present technology, there is provided an optical information recording medium on which recording address information is performed by a CAV or a zone CAV system, wherein the groove wobbling continuously is formed in advance to record the information to the groove and a land abutting the groove, wherein the address information is recorded by the wobble where a plurality of modulated waves which have been modulated by the address information are multiply formed, wherein the modulated wave is a higher harmonic wave whose frequency is a fundamental wave of the fundamental frequency of the wobble, or an integer times the fundamental frequency of the wobble, and wherein the one modulated wave is modulated by the address information of any one groove of the abutting grooves which interpose the land, and the other modulated wave are modulated by the address information of the other groove of the abutting grooves which interpose the land.

According to still another embodiment of the present technology, there is provided a reproducing apparatus including: a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and a decoding unit that decodes a plurality of the modulated waves extracted from the wobble signal, wherein in the decoding unit, the address information of one abutting land which interposes the groove is restored by decoding one modulated wave, and the address information of the other abutting land which interpose the groove is restored by decoding the other modulated wave, and wherein the address information of the groove is reproduced as the groove interposed by one and the other land whose address information has been restored.

According to still another embodiment of the present technology, there is provided a reproducing apparatus including: a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and a decoding unit that decodes a plurality of the modulated waves extracted from the wobble signal, wherein in the decoding unit, the address information of one abutting groove which interposes the land is restored by decoding one modulated wave, the address information of the other abutting groove which interposes the land is restored by decoding the other modulated wave, and wherein the address information of the land is reproduced as the land interposed by one and the other groove whose address information has been restored.

According to the embodiments of the present technology, it is possible to restore the address information in a time of reproducing the land as well as in a time of reproducing the groove.

### BRIEF DESCRIPTION OF THE DRAWINGS

FIG. 1 is a schematic diagram illustrating address data of a BD format;

FIG. 2 is a schematic diagram illustrating an ADIP unit of a BD format;

FIG. 3 is a schematic diagram illustrating a data structure of an ADIP word of a BD format;

FIG. 4 is a wave form diagram illustrating an MSK;

FIGS. 5A and 5B are wave form diagrams illustrating an STW;

FIGS. 6A and 6B are wave form diagrams illustrating an STW;

FIG. 7A is a schematic diagram illustrating a configuration example of an optical disc. FIG. 7B is an enlarged view illustrating an enlarged part of the optical disc of FIG. 7A;

FIGS. 8A and 8B are enlarged views illustrating an enlarged part of an optical disc;

FIGS. 9A and 9B are graphs illustrating an OFDM modulation;

FIGS. 10A and 10B are enlarged views illustrating an enlarged part of an optical disc;

FIGS. 11A and 11B are enlarged views illustrating an enlarged part of an optical disc;

FIGS. 12A to 12D are wave form views illustrating an example of a wobble wave form;

FIGS. 13A to 13D are wave form views illustrating an example of a wobble wave form;

FIGS. 14A to 14D are wave form views illustrating an example of a wobble wave form;

FIGS. 15A to 15D are wave form views illustrating an example of a wobble wave form;

FIGS. 16A to 16D are wave form views illustrating an example of a wobble wave form;

FIG. 17 is a block diagram illustrating a configuration example of an address recording apparatus;

FIG. 18 is a block diagram illustrating a configuration example of a disc reproducing apparatus; and

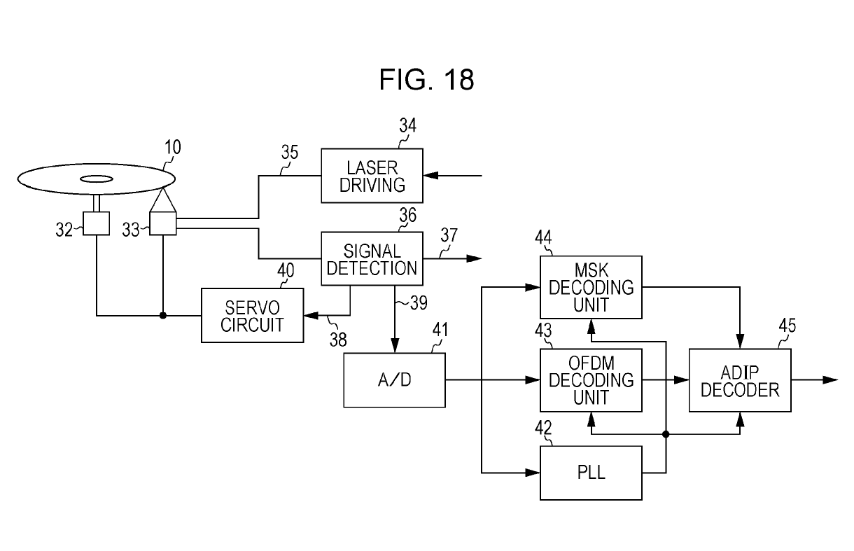

FIG. 19 is a block diagram illustrating a configuration example of an OFDM decoding unit.

### DETAILED DESCRIPTION OF EMBODIMENTS

Hereinafter, embodiments of the present technology will be described referring to the drawings. Embodiments described hereinafter are appropriate and particular examples of the present technology, and technically preferable various limitations are imposed. However, a scope of the present technology is not limited to such embodiments insofar as there is no description which has an intent of limiting the present technology particularly.

Hereinafter, a description will be given as follows:

### 1. BD Format

### 2. First Embodiment: Optical Information Recording Medium

### 3. Second Embodiment: Address Recording Apparatus

### 4. Third Embodiment: Disc Reproducing Apparatus

### 1. BD Format

In the present technology, a format of the address information and the like follow a BD (Blu-ray Disc (registered trademark)) format. According to this, it is possible to use a greater part of a technology of the BD which is a high-density optical disc as well as being applied practically. Thus, before entering into a description of the present disclosure, a description will be given regarding the address information in the BD format.

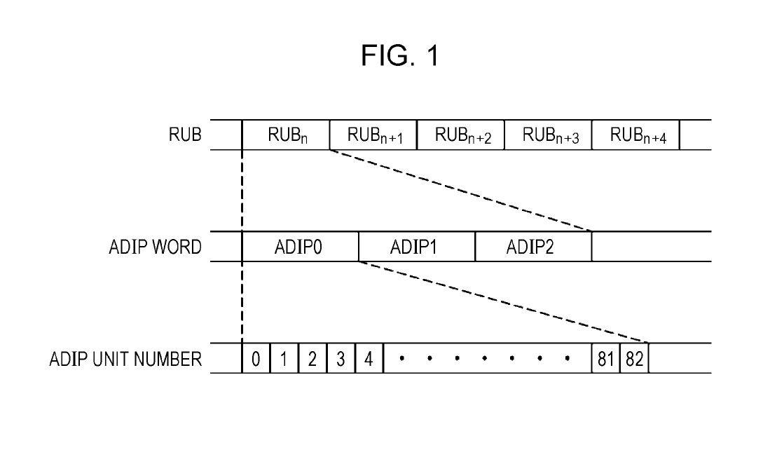

As shown in FIG. 1, main data to be written in is a series of RUB (Recording Unit Block) (RUBₙ₊₀, RUBₙ₊₁, RUBₙ₊₂, RUBₙ₊₃, . . . ). RUB is a unit to record the main data (recording reproducing data), and a predetermined length, for example, is set to 64 kbytes. 3 ADIP (Address In Pregroove) words ADIP0, ADIP1, and ADIP2 are allotted to every 1 RUB. ADIP0, ADIP1, and ADIP2 have the same address information mutually.

Further, 83 (unit numbers, 0 to 82) ADIP units are contained in one ADIP word. 24 bits of the address information, 12 bits of the auxiliary data, a reference area, and an error correction code, and the like are stored in one ADIP word. Such information is expressed by using, for example, 60 ADIP units among 83 ADIP units.

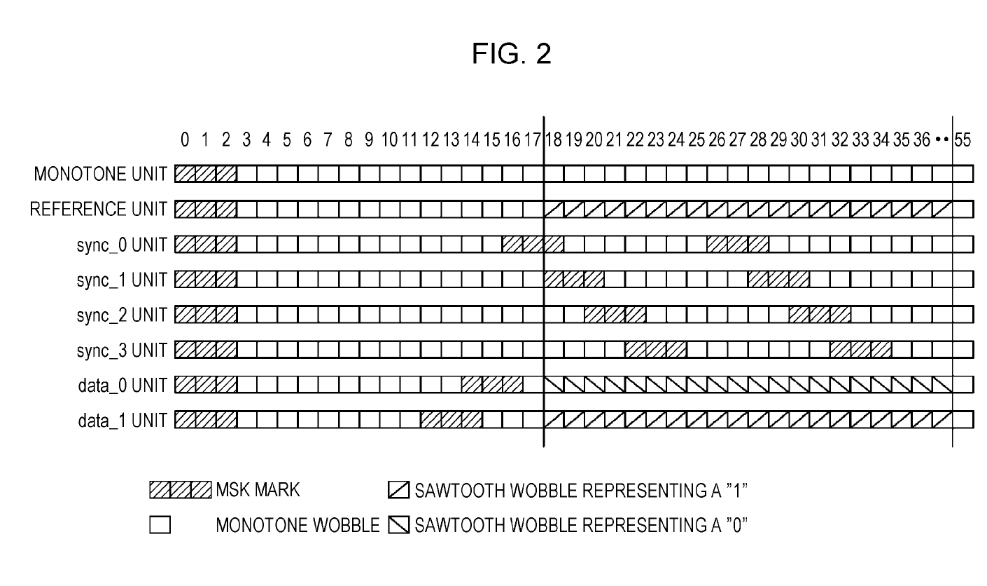

As shown in FIG. 2, a group of 56 wobbles in total is referred to as an ADIP unit, and one bit of “0” or “1”, synchronization information, a reference unit, or a monotone unit is expressed by using the ADIP unit. 1 wobble is, for example, one cycle of a fundamental wobble wave form (cos(2 πft)). Thus, 1 ADIP word is formed by (83×56) wobbles. In FIG. 2, 8 kinds (monotone unit, reference unit, 4 kinds of synchronization units, and 2 kinds of data units which respectively express “0” or “1” of the data) of the ADIP units are illustrated. Further, in FIG. 2, a group of 35 wobbles is illustrated due to a spatial limitation.

As shown in FIG. 2, when wobble numbers, 0 to 55 are assigned to the ADIP unit formed by 56 wobbles for a distinction, for example, a section and the like in which the wobble numbers are assigned from 0 to 2 are modulated to a MSK (Minimum Shift Keying), and the wobble numbers of the reference unit and the data unit from 18 to 54 are modulated to a STW (Saw Tooth Wobble). The monotone wobble not modulated is wobbled to a fundamental wave of the predetermined frequency (cos(2πft)).

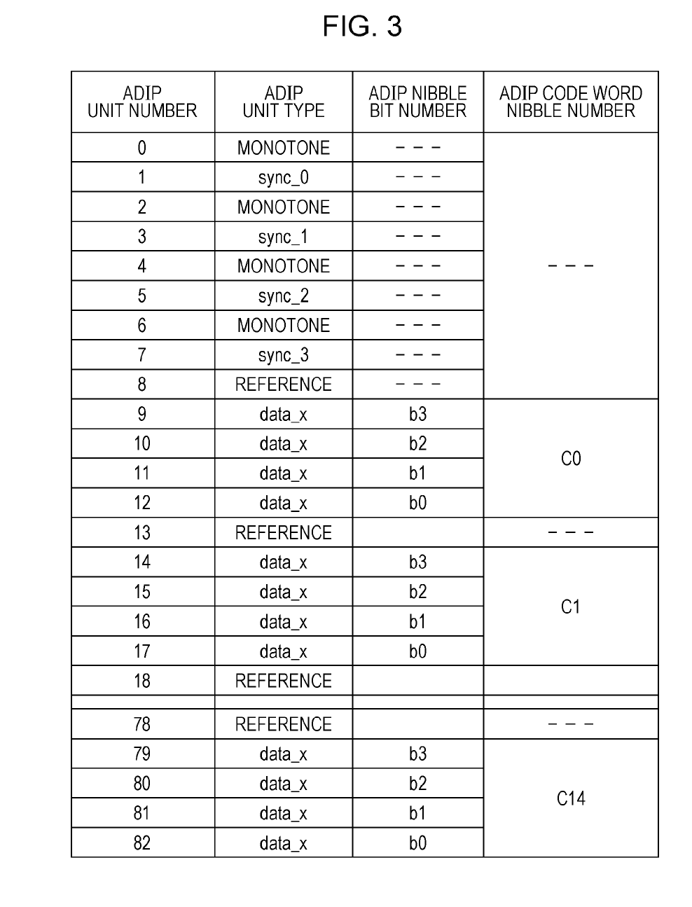

The ADIP word has a data structure as shown in FIG. 3. An ADIP unit type in FIG. 3 corresponds to a kind of the ADIP unit in FIG. 2. 60 bits of data is contained in one ADIP word.

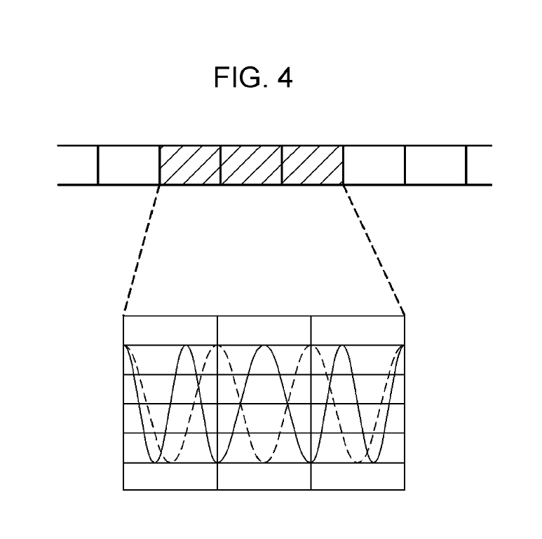

As shown in FIG. 4, the MSK is configured by 3 wobbles. Since a frequency of a preceding wobble and a following wobble is 1.5 times a fundamental wave, the wave form of a central wobble is polarity reversed at a portion which is not the MSK. The MSK is arranged to correspond to a head portion of each ADIP unit (wobbles numbered from 0 to 2), and is used to detect a head portion of the ADIP unit.

Further, as shown in FIG. 2, the MSK is arranged from the head portion of the ADIP unit of data 0 to positions of the 14th to 16th wobbles, and the MSK is arranged from the head portion of the ADIP unit of data 1 to positions of the 12th to 14th wobbles. Thus, 0 and 1 of the data are expressed by positions of the MSK.

In the ADIP unit of the data 0, while the MSK is set to 0, a STW which expresses 0 at a section of the 18th to 55th wobbles from the head portion is arranged. In the ADIP unit of data 1, while the MSK is set to 1, the STW which expresses 1 at a section of the 18th to 55th wobbles from the head portion is arranged.

A STW method is to generate a modulated wave form similar to a saw tooth by adding or subtracting a secondary higher harmonic wave (sin(2π2ft)) to the fundamental wave (cos(2πft)). An amplitude of the secondary higher harmonic wave is set to a small size of ¼ of the fundamental wave form. Since any one of addition and subtraction is selected by “0” or “1” of the data, the modulated wave form becomes to be changed. A saw tooth wobble is repeated and recorded at the section where the wobble numbers of the reference unit and the data unit are 18 to 54.

Thus, the reason to use two kinds of methods is to supplement a disadvantage of each method. In the MSK method, since 1 bit is recorded by modulating 3 wobbles of the head portion of the ADIP unit, it is possible to use the MSK as a basis to decide the position of the data in a time of reproduction. On the other hand, the STW method is repeated and recorded across a wide range as a small wave form change, and in a time of reproduction, the STW method determines “0” or “1” by integrating a reproduced signal. Thus, it is difficult to use a reproduced signal as information for detecting an end of the data. However, the MSK method that is a local recording method is likely to be affected by a defect resulting from a dust and the like. There is an advantage that the STW method is not likely to be affected by such a defect since the STW method is recorded over a longer period.

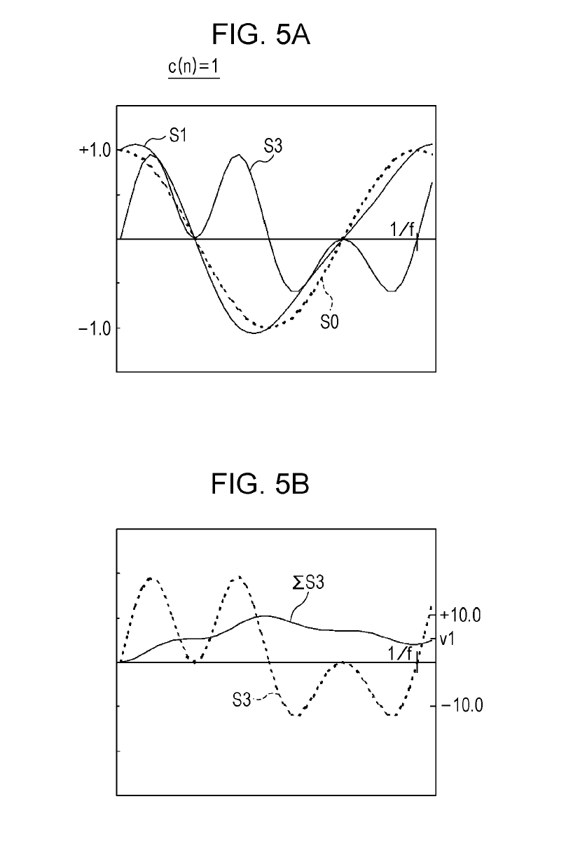

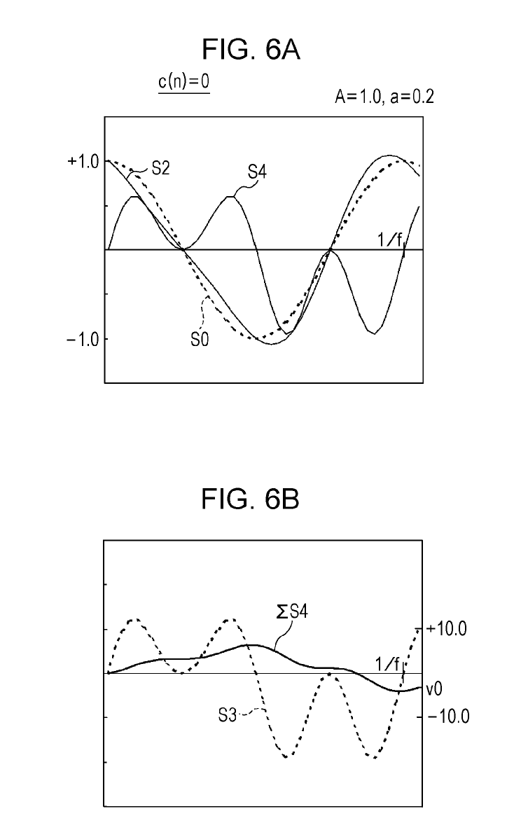

A more specific description will be given regarding a modulated wobble signal of the STW method referring to FIGS. 5A to 6B. In FIGS. 5A to 6B, a horizontal axis refers to a time axis, one cycle (that is, one wobble) of the fundamental wobble wave form is illustrated, and a vertical axis refers to a normalized amplitude. FIG. 5A illustrates the wave form in a case where data c(n) is “1”, and FIG. 6A illustrates the wave form in a case where the data c(n) is “0”.

In FIGS. 5A and 6A, the wave form drawn in a broken line is a fundamental wobble wave form S0 (=cos(2πft)). In a case where c(n)=1, formed is a wave form S1 which is modulated by adding a sin signal that has the frequency 2 times as great as the fundamental wobble wave form S0. That is, S1=A cos(2πft)+a sin(2π2ft). A relationship of A>a is established, and for example, A=1, and a=0.2. This modulated wobble wave form S1 is a wave form to be modulated so that, when seen in a direction of time, a rise (which is an outer side direction of a disc when seen in a radial direction of the disc) is gradual compared to the fundamental wobble wave form S0, and a decline (which is an inner side direction of a disc when seen in the radial direction of the disc) is steep compared to the fundamental wobble wave form S0.

As shown in FIG. 6A, in a case where c(n)=“0”, formed is a wave form S2 which is modulated by subtracting the sin signal that has the frequency 2 times as great as the fundamental wobble wave form S0. That is, S2=A cos(2πft)−a sin(2π2ft). This modulated wobble wave form S2 is the wave form to be modulated so that, when seen in the direction of time, the rise (which is the outer side direction of the disc) is steep compared to the fundamental wobble wave form S0, and the decline (which is the inner side direction of the disc) is gradual compared to the fundamental wobble wave form S0. In any one of modulated wobble wave forms S1 and S2, a zero crossing point becomes the same phase as the fundamental wobble wave form, and it is formed to be capable of easily extracting the clock in a reproduction side.

FIGS. 5A and 6A illustrate that each of wave forms, S3 and S4 is to be formed by multiplying the sin signal (sin(2π2ft)) that has the frequency 2 times as great as the fundamental wave which is used in processing of the reproduction side to a reproduced modulated wobble signal. That is, the wave form S3 is obtained by a reproduced modulated wobble wave form S1×sin(2π2ft), and the wave form S4 is obtained by a reproduced modulated wobble wave form S2×sin(2π2ft).

In the reproduction side, as shown respectively in FIGS. 5B and 6B, integrated values ΣS3 and ΣS4 are obtained by integrating (adding up) each of the wave forms S3 and S4 over one wobble cycle. The integrated value ΣS3 becomes a positive value v1 in a point of time when one wobble cycle has elapsed. On the other hand, the integrated value ΣS4 becomes a negative value v0 in a point of time when one wobble cycle has elapsed. The integrated value is dealt with, for example, v1=+1, v0=−1.

Since 1 bit of the data is expressed by 56 wobbles, if all is +1, +56 are obtained as a result of integrating 56 wobbles, and if all is −1, −56 is obtained as a result of integrating 56 wobbles. The same code sequence as used in a time of recording has been multiplied to a regenerated chip series obtained as the integrated value of each wobble, and 1 bit (“1”/“0”) of the data is determined based on the result of integrating 56 wobbles regarding such a result.

Difference with BD Format

In an embodiment of the present technology, a main difference with the above described BD format is, for example, as the follows. The BD format is to rotate the disc at a constant linear velocity (hereinafter, referred to as CLV), and on the contrary, the present technology is to rotate the disc at a constant angular velocity (hereinafter, referred to as CAV). A plurality of zones are formed by dividing the radial direction of the disc, and in the zones, a zone CAV which performs a CAV control may be adopted. The BD format is a groove recording method of recording in the groove, and on the contrary, the present technology performs recording in the both sides of the groove and the land. Further, as described above, what corresponds to a ditch is referred to as the groove, and a track formed by the groove is referred to as a groove track. The groove is defined as a portion irradiated by the laser beam in a time of manufacturing an optical disc, an area which is interposed between grooves is referred to as a land, and the track formed by the land is referred to as a land track. As for the laser beam, the laser beam of one beam is used, and it is possible to easily perform mastering the disc where the address information for a method of recording land-groove has been recorded by an exposure device of one beam. An OFDM (Orthogonal Frequency Division Multiplexing) modulation is applied to record the address information by the wobble.

### 2. First Embodiment

### Optical Information Recording Medium

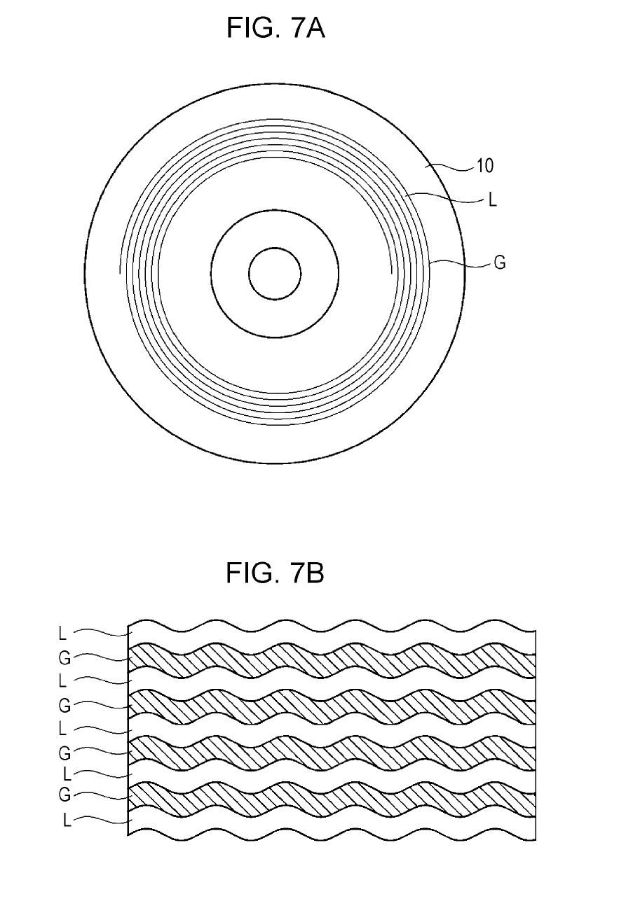

An optical information recording medium according to a first embodiment of the present technology will be described. FIGS. 7A and 7B illustrate a configuration example of the optical information recording medium according to the first embodiment. The optical information recording medium is, for example, a high density recording optical disc of a disk shape. FIG. 7A is a schematic diagram illustrating an optical disc. FIG. 7B is a view illustrating an enlarged part of the optical disc of FIG. 7A.

As shown in FIGS. 7A and 7B, in an optical disc 10, provide is a land L, an area which is interposed between a ditch shaped groove G that is continued in a spiral shape in the direction from an inner circumference to an outer circumference, or in the direction from the outer circumference to the inner circumference, and an abutting groove G. In the optical disc 10, data is recorded in a land-groove recording method in which the data is recorded to the land L and the groove G. In the optical disc 10, address information is recorded in a method that modulates a signal which forms a wobble by the address information.

### Recording and Reproduction of Address Information

An example of recording and reproducing the address information will be described in the optical disc of the present technology. Recording and reproducing the address information of the present technology is applied to the above mentioned optical disc.

### First Example of Recording and Reproducing Address Information of Optical Disc

A first example of recording and reproducing the address information will be described in the optical disc of the present technology.

### Recording of Address Information

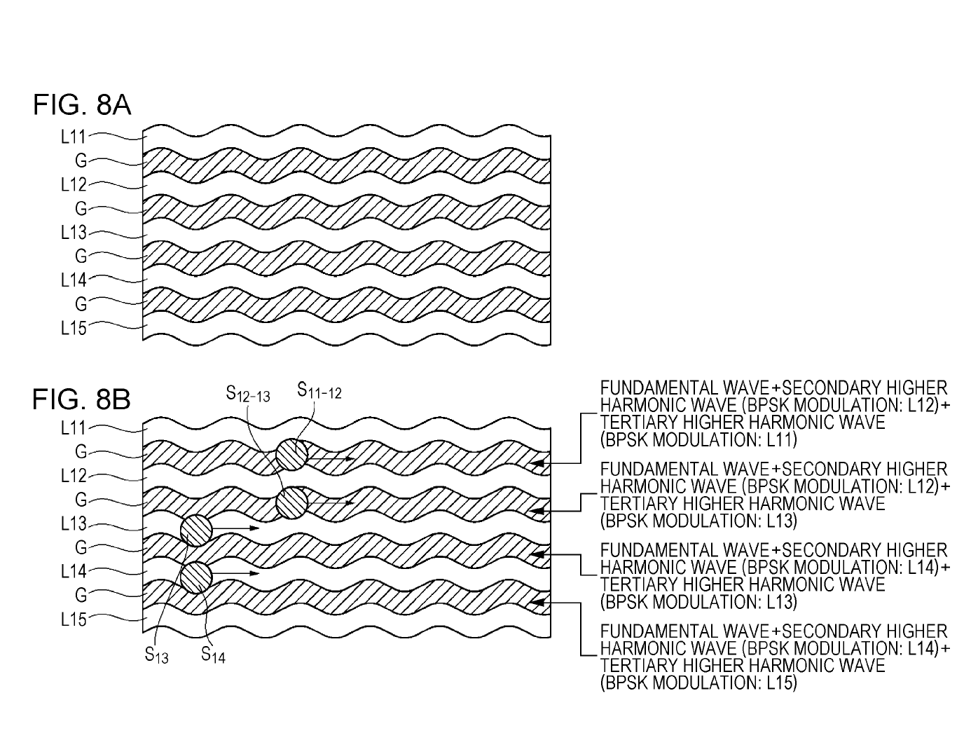

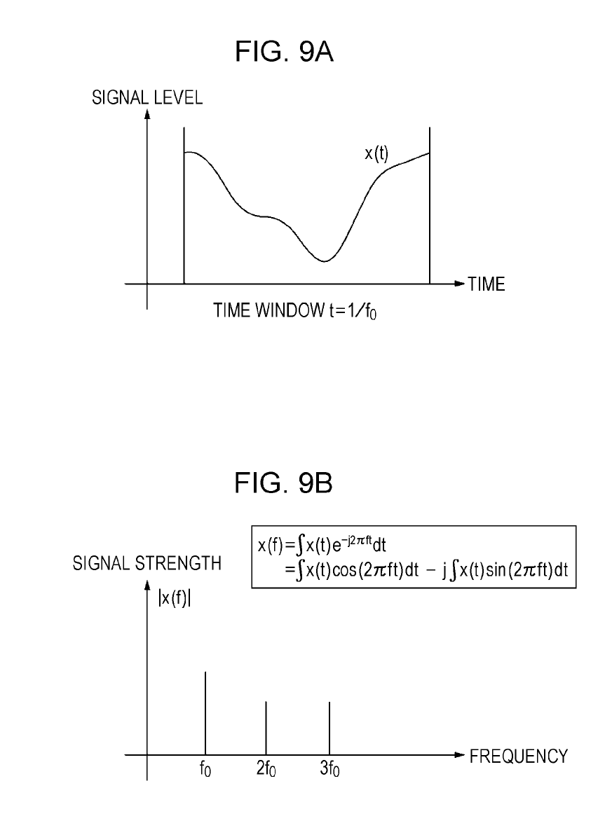

FIGS. 8A and 8B are enlarged views illustrating an enlarged part of the optical disc for describing the recording of the address information. In the recording of the address information of the optical disc, for example, the address information is recorded by setting a fundamental frequency of the wobble to f₀, setting the inverse number T=1/f₀ to an unit recording section of the address information, and using a frequency component of an integer times the fundamental frequency f₀. Further, the OFDM (Orthogonal Frequency Division Multiplexing) modulation is applied to the recording of the address information of the present technology. When the recording method is described briefly, for example, as shown in FIGS. 9A and 9B, it is possible to separate and detect a strength and a phase of each higher harmonic wave component by determining a time window, and Fourier transforming a reproduced signal x(t). And by using the result of such separation and detection of each higher harmonic wave component, the address information is recorded corresponding to the OFDM signal where a signal that has modulated each harmonic wave component of the wobble by the address information has been multiplexed.

As for the recording method of the present technology to record the address information to the optical disc, the CAV method that radially gathers unit recording sections, and rotates the disc at a constant angular velocity is adopted. Further, a plurality of zones may be formed by dividing a radial direction of the disc, and in a zone, a zone CAV which performs a CAV control may be adopted.

In the first example, track numbers 1 to n (n is an integer of 2 or more) are assigned to land tracks in an order facing from a center to an outer circumference. Further, FIGS. 8A and 8B illustrate a land 11 to a land 15 where track numbers 11, 12, 13, 14, and 15 are assigned. For example, a fundamental frequency of a wobble is constantly set to be unmodulated, and is used to detect a timing of a clock and the unit recording section of the address information. The address information of the land of an odd track number is recorded by BPSK (Binary Phase Shift Keying) modulating a secondary higher harmonic wave component of the fundamental frequency. The address information of the land of the even track number is recorded by BPSK modulating a tertiary higher harmonic wave component of the fundamental frequency.

That is, for example, track numbers 1 to n (n is an integer of 2 or more) are assigned to land tracks in an order facing from a center to an outer circumference, a superposed wave form is generated by superposing the fundamental wave of a non-modulation, the secondary higher harmonic wave component which has been BPSK modulated by one side (land address of the even track number) of abutting land addresses that interpose a groove, and the tertiary higher harmonic wave component which has been BPSK modulated by the other side (land address of an odd track number) of the abutting land addresses which interpose the groove, and the address information of both sides of abutting lands that interpose the groove is recorded in the wobble of the groove.

Particularly, for example, in FIG. 8B, in an example that records a groove G between a land L12 of an even track number 12 and a land L11 of an odd track number 11, the superposed wave form is generated by superposing the fundamental wave of non-modulation, the secondary higher harmonic wave component modulated by the land address of the land L12 of the even track number, and the tertiary higher harmonic wave component modulated by the land address of the land L11 of an odd track number, and address information of both abutting the land L12 and the land L11 that interpose the groove G are recorded in the wobble of the groove G.

In addition, for example, in FIG. 8B, in an example that records a groove G between a land L12 of the even track number 12 and a land L13 of an odd track number 13, the superposed wave form is generated by superposing the fundamental wave of non-modulation, the secondary higher harmonic wave component modulated by the land address of the land L12 of the even track number, and the tertiary higher harmonic wave component modulated by the land address of the land L13 of an odd track number, and address information of both abutting land L12 and land L13 that interpose the groove G are recorded in the wobble of the groove G.

In addition, for example, in FIG. 8B, in an example that records a groove G between a land L13 of the odd track number 13 and a land L14 of an even track number 14, the superposed wave form is generated by superposing the fundamental wave of non-modulation, the secondary higher harmonic wave component modulated by the land address of the land L14 of the even track number, and the tertiary higher harmonic wave component modulated by the land address of the land L13 of the odd track number, and address information of both abutting land L13 and land L14 that interpose the groove G are recorded in the wobble of the groove G.

In addition, for example, in FIG. 8B, in an example that records a groove G between a land L15 of an odd track number 15 and a land L14 of the even track number 14, the superposed wave form is generated by superposing the fundamental wave of non-modulation, the secondary higher harmonic wave component modulated by the land address of the land L14 of the even track number, and the tertiary higher harmonic wave component modulated by the land address of the land L15 of the odd track number, and address information of both abutting land L15 and land L14 that interpose the groove G are recorded in the wobble of the groove G.

That is, as shown in FIG. 8B, the following superposed wave forms are recorded in the wobble of the groove G.

The groove G (between the L11 and the L12): the superposed wave form of the fundamental wave, the secondary higher harmonic wave component (the BPSK modulation by the land address of the L12), and the tertiary higher harmonic wave component (the BPSK modulation by the land address of the L11).

The groove G (between the L12 and the L13): the superposed wave form of the fundamental wave, the secondary higher harmonic wave component (the BPSK modulation by the land address of the L12), and the tertiary higher harmonic wave component (the BPSK modulation by the land address of the L13).

The groove G (between the L13 and the L14): the superposed wave form of the fundamental wave, the secondary higher harmonic wave component (the BPSK modulation by the land address of the L14), and the tertiary higher harmonic wave component (the BPSK modulation by the land address of the L13).

The groove G (between the L14 and the L15): the superposed wave form of the fundamental wave, the secondary higher harmonic wave component (the BPSK modulation by the land address of the L14), and the tertiary higher harmonic wave component (the BPSK modulation by the land address of the L15).

### Reproduction of Address Information

A reproduction of the address information of the optical disc where the address information has been recorded as described above will be described.

### Reproduction of Land Address

In the reproduction of the address information of the land of the optical disc, the address information is reproduced by BPSK decoding the secondary higher harmonic wave component or the tertiary higher harmonic wave component of the reproduced signal (wobble signal) of the wobble.

For example, a fundamental frequency component of the wobble, the secondary higher harmonic wave component and the tertiary higher harmonic wave component are separated and extracted from the wobble signal according to a principle of the Fourier series development. The address information is reproduced by detecting the unit recording section from the fundamental frequency component of the non-modulation, and by BPSK decoding the secondary higher harmonic wave component or the tertiary higher harmonic wave component. Further, the secondary higher harmonic wave component and the tertiary higher harmonic wave component are modulated waves which have been BPSK modulated by the address information as described above.

For example, in the reproduction of the address information of the land of the odd track number where the address information has been recorded as described above, the address information is restored by BPSK decoding the tertiary higher harmonic wave component modulated by the reproduced address information of the land. In addition, in the reproduction of the address information of the land of the even track number, the address information is restored by BPSK decoding the secondary higher harmonic wave component modulated by the reproduced address information of the land.

Particularly, for example, in FIG. 8B, in the reproduction of the address information of the land L13 (of the odd track number) where a reproduction spot S₁₃ is present in the land L13, the address information is restored by BPSK decoding the tertiary higher harmonic wave component modulated by the address information of the land L13.

In addition, for example, in FIG. 8B, in the reproduction of the address information of the land L14 (of the even track number) where a reproduction spot S₁₄ is present in the land L14, the address information is restored by BPSK decoding the secondary higher harmonic wave component modulated by the address information of the land L14.

### Reproduction of Groove Address

On the other hand, in the reproduction of the address information of the groove, the address information is restored by BPSK decoding the secondary higher harmonic wave component and the tertiary higher harmonic wave component of the wobble signal. For example, the fundamental frequency component, the secondary higher harmonic wave component and the tertiary higher harmonic wave component are separated and extracted from the wobble signal according to the principle of the Fourier series development. For example, the address information is restored by detecting the unit recording section from a unmodulated fundamental frequency, and by BPSK decoding the secondary higher harmonic wave component and the tertiary higher harmonic wave component.

The secondary higher harmonic wave component is modulated by the address information of the land of the even track number abutting the groove which reproduces the address information. The tertiary higher harmonic wave component is modulated by the address information of the land of the odd track number abutting the groove which reproduces the address information. In the reproduction of the address information of the groove, the address information of an abutting land of the even track number is restored by BPSK decoding the secondary higher harmonic wave component, and together with this, the address information of an abutting land of the odd track number is restored by BPSK decoding the tertiary higher harmonic wave component. And the address information is defined as the groove interposed by the abutting lands of both sides where the address information has been restored, the address information of the groove is reproduced.

Particularly, for example, in FIG. 8B, in the reproduction of the address of the groove G where a reproduction spot S₁₁₋₁₂ is present in the groove G, and which is between the land L11 of the odd track number 11 and the land L12 of the even track number 12, the address information of the land L12 is restored by decoding the secondary higher harmonic wave component modulated by the address information of the land L12. The address information of the land L11 is restored by decoding the tertiary higher harmonic wave component modulated by the address information of the land L11. And the address information of the groove G is reproduced by defining the address information of the groove G interposed by the land L11 and the land L12 abutting each other.

Similarly, in the reproduction of the address of the groove G where a reproduction spot S₁₂₋₁₃ is present in the groove G between the land L12 of the even track number 12, and the land L13 of the odd track number 13, the address information of the land L12 is restored by decoding the secondary higher harmonic wave component modulated by the address information of the land L12. The address information of the land L13 is restored by decoding the tertiary higher harmonic wave component modulated by the address information of the land L13. And the address information of the groove G is reproduced by defining the address information as the groove G interposed by the land L13 and the land L12 abutting each other.

### Second Example of Recording and Reproduction of Address Information in Optical Disc

A second example of recording and reproducing the address information will be described in the optical disc of the present technology. Further, hereinafter, a description regarding the same points as the first example will be appropriately omitted.

### Recording of Address Information

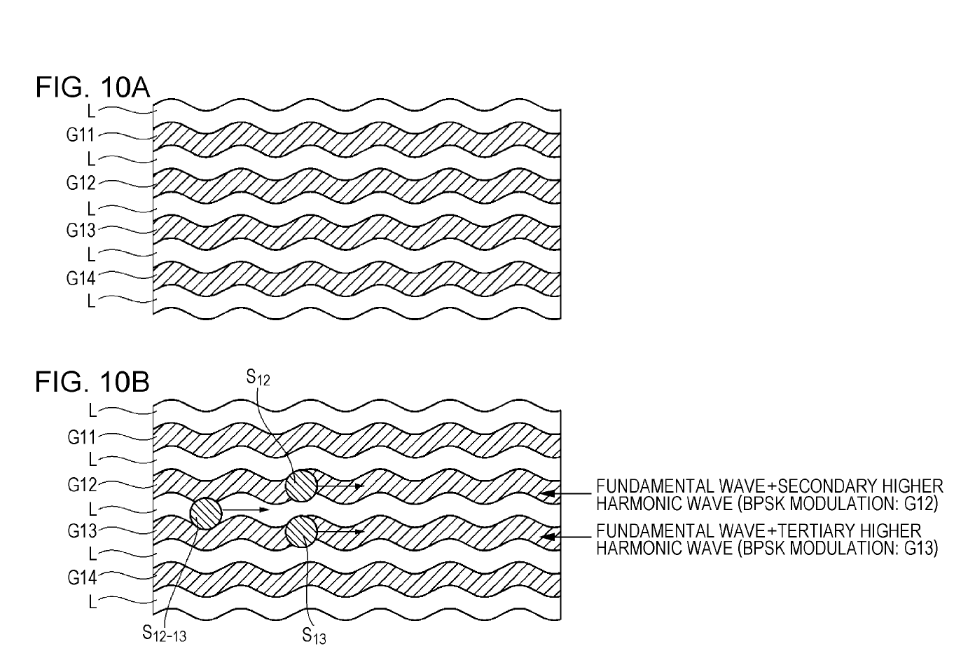

FIGS. 10A and 10B are views illustrating an enlarged part of an optical disc for describing recording the address information. In the second example, the track numbers 1 to n (n is an integer of 2 or more) are assigned to the groove track in an order facing from the center to the outer circumference. Further, FIGS. 10A and 10B illustrate the grooves G11 to G14 where the track numbers 11, 12, 13, and 14 are assigned. The fundamental frequency of the wobble is constantly set to be unmodulated, and is used to detect the timing of the clock and the unit recording section of the address information. In addition, the address information of the groove of the even track number is recorded by, for example, BPSK modulating the secondary higher harmonic wave component of the fundamental frequency, for example, in each of the unit recording section. The address information of the groove of the odd track number is recorded by, for example, BPSK modulating the tertiary higher harmonic wave component of the fundamental frequency.

That is, for example, track numbers 1 to n (n is an integer of 2 or more) are assigned to groove tracks in an order facing from the center to the outer circumference, and in a case of the groove address of the even track number, the superposed wave form that has superposed the fundamental wave of the non-modulation, and the secondary higher harmonic wave component which has been BPSK modulated by the groove address is generated to be recorded in the wobble of the groove. In a case of the groove address of the odd track number, the superposed wave form that has superposed the fundamental wave of the non-modulation, and the tertiary higher harmonic wave component which has been BPSK modulated by the groove address is generated to be recorded in the wobble of the groove.

Particularly, for example, in FIGS. 10A and 10B, in an example that records a groove G12 of the even track number 12, the superposed wave form that has superposed the fundamental wave of the non-modulation, and the secondary higher harmonic wave component modulated by the groove address of the groove G12 of the even track number is generated to be recorded in the wobble of the groove G12. In addition, for example, in FIGS. 10A and 10B, in an example that records a groove G13 of the odd track number 13, the superposed wave form that has superposed the fundamental wave of the non-modulation, and the tertiary higher harmonic wave component modulated by the groove address of the groove G13 of the odd track number is generated to be recorded in the wobble of the groove G13.

That is, the following superposed wave forms are recorded in the wobble of the groove.

The groove G12: the superposed wave form of the fundamental wave and the secondary higher harmonic wave component (the BPSK modulation by the groove address of the G12).

The groove G13: the superposed wave form of the fundamental wave and the secondary higher harmonic wave component (the BPSK modulation by the groove address of the G13).

### Reproduction of Address Information

A reproduction of address of the optical disc where the address information has been recorded as described above will be described.

### Reproduction of Land Address

In the reproduction of the address information of the land of the optical disc, the address information is restored by BPSK decoding the secondary higher harmonic wave component and the tertiary higher harmonic wave component of the wobble signal. For example, the fundamental frequency component of the wobble, the secondary higher harmonic wave component and the tertiary higher harmonic wave component are separated and extracted from the wobble signal according to a principle of the Fourier series development. The address information is restored by detecting the unit recording section from the fundamental frequency component of the non-modulation, and by BPSK decoding the secondary higher harmonic wave component or the tertiary higher harmonic wave component. Further, the secondary higher harmonic wave component and the tertiary higher harmonic wave component are modulated waves which have been modulated by the address information.

The secondary higher harmonic wave component is modulated by the address information of the groove of the even track number abutting the land which reproduces the address information. The tertiary higher harmonic wave component is modulated by the address information of the groove of the odd track number which reproduces the address information. In the reproduction of the address information of the land, the address information of an abutting groove of the even track number is restored by BPSK decoding the secondary higher harmonic wave component, and together with this, the address information of an abutting groove of the odd track number is restored by BPSK decoding the tertiary higher harmonic wave component. And the address information of the land is reproduced by defining the address information as the land interposed by the abutting grooves of both sides.

Particularly, for example, in FIG. 10B, in the reproduction of the address information of the land L where a reproduction spot S₁₂₋₁₃ is present in the land L, and which is between the groove G12 of the even track number 12 and the groove G13 of the track number 13, the address information of the groove G12 is restored by BPSK decoding the secondary higher harmonic wave component corresponding to the address information of the groove G12. The address information of the groove G13 is restored by BPSK decoding the tertiary higher harmonic wave component corresponding to the address information of the groove G13. And the address information of the land L is reproduced by defining the address information as the land L interposed by the groove G12 and the groove G13 abutting each other.

### Reproduction of Groove Address

In the reproduction of the address information of the groove of the optical disc, the address information is restored by BPSK decoding the secondary higher harmonic wave component and the tertiary higher harmonic wave component of the wobble signal.

For example, in the reproduction of the address information of the groove of the odd track number where the address information has been recorded as described above, the address information is restored by BPSK decoding the tertiary higher harmonic wave component modulated by the reproduced address information of the groove. In addition, in the reproduction of the address information of the groove of the even track number, the address information is restored by decoding the secondary higher harmonic wave modulated by the reproduced address information of the groove.

Particularly, for example, in FIG. 10B, in the reproduction of the address information of the groove G12 (even track number) where a reproduction spot S₁₂ is present in the groove G12, the address information is restored by BPSK decoding the secondary higher harmonic wave component modulated by the address information of the groove G12.

In addition, for example, in FIG. 10B, in the reproduction of the address information of the groove G13 (odd track number) where a reproduction spot S₁₃ is present in the groove G13, the address information is restored by BPSK decoding the tertiary higher harmonic wave component modulated by the address information of the groove G13.

### Third Example of Recording and Reproduction of Address Information in Optical Disc

A Third example of recording and reproducing the address information will be described in the optical disc of the present technology. Further, hereinafter, a description regarding the same points as the first example will be appropriately omitted.

### Recording of Address Information

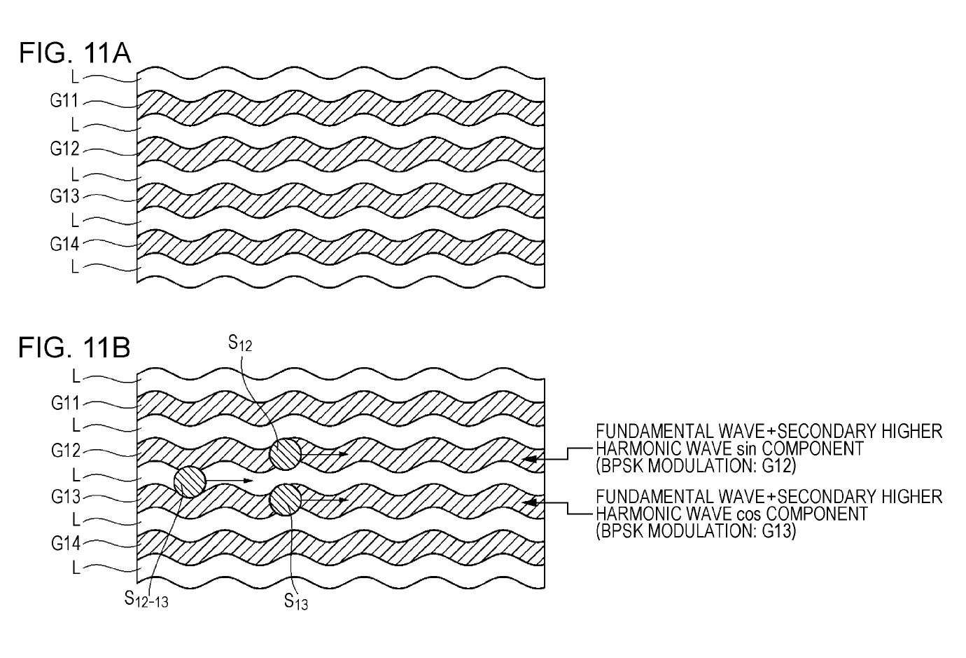

FIGS. 11A and 11B are views illustrating an enlarged part of an optical disc for describing recording the address information. In the third example, the track numbers 1 to n (n is an integer of 2 or more) are assigned to the groove track in an order facing from the center to the outer circumference. Further, FIGS. 11A and 11B illustrate the grooves G11 to G14 where the track numbers 11, 12, 13, and 14 are assigned.

The fundamental frequency of the wobble is constantly set to be unmodulated, and is used to detect the timing of the clock and the unit recording section of the address information. In addition, the address information of the groove of the even track number and the groove of the odd number is recorded by, for example, QPSK (quadrature phase shift keying) modulating the secondary higher harmonic wave component of the fundamental frequency, in each of the unit recording section. That is, the address information of the groove of the even track number is recorded by BPSK modulating the secondary higher harmonic wave sin component of the fundamental frequency, and the address information of the groove of the odd track number is recorded by BPSK modulating the secondary higher harmonic wave cos component of the fundamental frequency. In other words, the address information of the groove is recorded by modulating a phase of the secondary higher harmonic wave component to two values 0° or 180°, or the address information of the groove is recorded by modulating a phase of the secondary higher harmonic wave component to two values 90° or 270°.

That is, for example, track numbers 1 to n (n is an integer of 2 or more) are assigned to groove tracks in an order facing from the center to the outer circumference, and in a case of the groove address of the even track number, the superposed wave form that has superposed the fundamental wave of the non-modulation, and the secondary higher harmonic wave sin component which has been BPSK modulated by the groove address is generated to be recorded in the wobble of the groove. In the groove address of the odd track number, the superposed wave form that has superposed the fundamental wave of the non-modulation, and the secondary higher harmonic wave cos component which has been BPSK modulated by the groove address is generated to be recorded in the wobble of the groove.

Particularly, for example, in FIGS. 11A and 11B, in an example that records a groove G12 of the even track number 12, the superposed wave form that has superposed the fundamental wave of the non-modulation, and the secondary higher harmonic wave sin component modulated by the groove address of the groove G12 of the even track number is generated to be recorded in the wobble of the groove G12. In addition, for example, in FIGS. 11A and 11B, in an example that records a groove G13 of the odd track number 13, the superposed wave form that has superposed the fundamental wave of the non-modulation, and the secondary higher harmonic wave cos component modulated by the groove address of the groove G13 of the odd track number is generated to be recorded in the wobble of the groove G13.

That is, the following superposed wave forms are recorded in the wobble of the groove.

The groove G12: the superposed wave form of the fundamental wave and the secondary higher harmonic wave sin component (the BPSK modulation by the groove address of the G12).

The groove G13: the superposed wave form of the fundamental wave and the secondary higher harmonic wave cos component (the BPSK modulation by the groove address of the G13).

### Reproduction of Address Information

A reproduction of an address of the optical disc where the address information has been recorded as described above will be described.

### Reproduction of Land Address

In the reproduction of the address information of the land of the optical disc, the address information is restored by BPSK decoding the secondary higher harmonic wave sin component and the secondary higher harmonic wave cos component of the wobble signal. For example, the fundamental frequency component of the wobble, the secondary higher harmonic wave sin component and the secondary higher harmonic wave cos component are separated and extracted from the wobble signal according to the principle of the Fourier series development. The address information is restored by detecting the unit recording section from the fundamental frequency component of the non-modulation, and by BPSK decoding the secondary higher harmonic wave sin component or the secondary higher harmonic wave cos component. Further, the secondary higher harmonic wave sin component and the secondary higher harmonic wave cos component are modulated waves which have been modulated by the address information.

The secondary higher harmonic wave sin component is modulated by the address information of the groove of the even track number abutting the land which reproduces the address information. The secondary higher harmonic wave cos component is modulated by the address information of the groove of the odd track number which reproduces the address information. In the reproduction of the address information of the land, the address information of an abutting groove of the even track number is restored by BPSK decoding the secondary higher harmonic wave sin component, and together with this, the address information of an abutting groove of the odd track number is restored by BPSK decoding the secondary higher harmonic wave cos component. And the address information of the land is reproduced by defining the address information as the land interposed by the abutting grooves of both sides.

Particularly, for example, in FIG. 11B, in the reproduction of the address of the land L where the reproduction spot S₁₂₋₁₃ is present in the land L, and which is between the groove G12 of the even track number 12 and the groove G13 of the track number 13, the address information of the groove G12 is restored by BPSK decoding the secondary higher harmonic wave sin component corresponding to the address information of the groove G12. The address information of the groove G13 is restored by BPSK decoding the secondary higher harmonic wave cos component corresponding to the address information of the groove G13. And the address information is reproduced by defining the address information as the land interposed by the groove G12 and the groove G13 abutting each other.

### Reproduction of Groove Address

In the reproduction of the address information of the groove of the optical disc, the address information is restored by BPSK decoding the secondary higher harmonic wave sin component, or the secondary higher harmonic wave cos component of the wobble signal.

For example, in the reproduction of the address information of the groove of the odd track number where the address information has been recorded as described above, the address information is restored by BPSK decoding the secondary higher harmonic wave cos component modulated by reproduced the address information of the groove. In addition, in the reproduction of the address information of the groove of the even track number, the address information is restored by decoding the secondary higher harmonic wave modulated by the reproduced address information of the groove.

Particularly, for example, in FIG. 11B, in the reproduction of the address information of the groove G12 (even track number) where a reproduction spot S₁₂ is present in the groove G12, the address information is restored by BPSK decoding the secondary higher harmonic wave sin component modulated by the address information of the groove G12.

In addition, for example, in FIG. 11B, in the reproduction of the address information of the groove G13 (odd track number) where a reproduction spot S₁₃ is present in the groove G13, the address information is restored by BPSK decoding the secondary higher harmonic wave cos component modulated by the address information of the groove G13.

### Other Example of Recording and Reproduction of Address Information

In the other example of the recording and the reproduction of the address information, the address information may be recorded similarly to the above mentioned manner by using a higher harmonic wave component exceeding a tertiary such as a fourthly higher harmonic wave component and a fifthly higher harmonic wave component instead of the secondary higher harmonic wave component and/or the tertiary higher harmonic wave component. In addition, as a modulation method that modulates a higher harmonic wave component, a phase multi-level modulation or an amplitude multi-level modulation such as a QPSK modulation or 16 QAM (Quadrature Amplitude Module) modulation similarly to the third example may be used. In addition, by modulating the fundamental wave, the address information may be recorded. The clock may be reproduced from the higher harmonic wave component other than the fundamental wave.

### Example of Wobble Wave Form

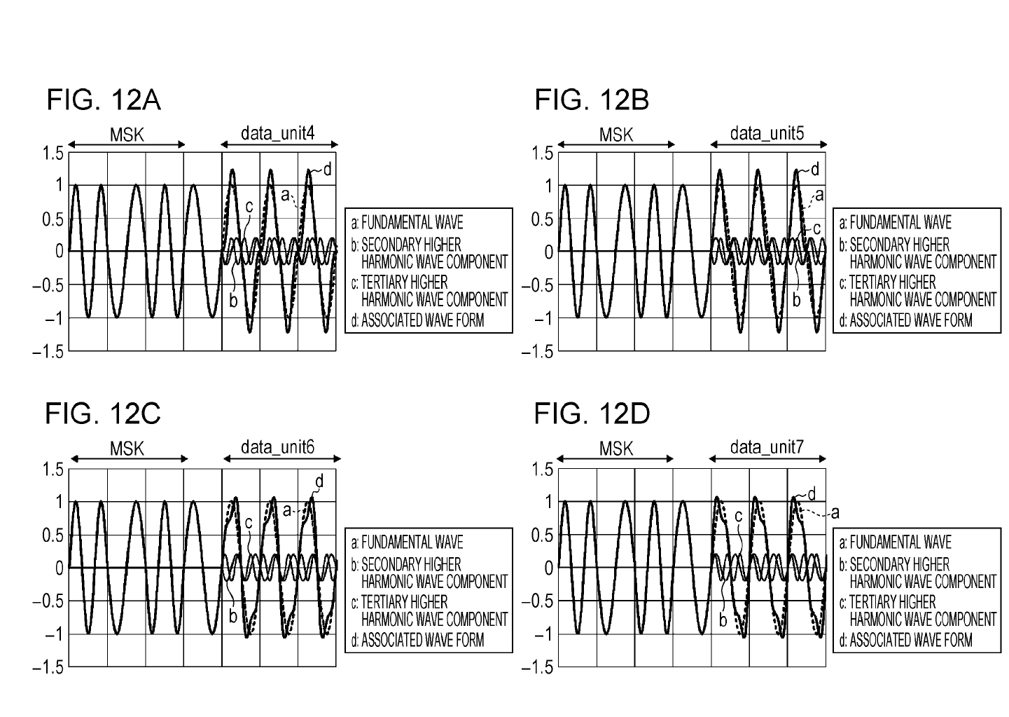

Hereinafter, an example of a wobble wave form will be described. FIGS. 12A to 12D, for example, correspond to the first example or the second example of the recording and the reproduction in the optical disc. Next to the MSK, a monotone wobble is arranged. In the next section, the wobble of the data unit which has been OFDM modulated, and is illustrated as an associated wave form d is arranged. For example, FIG. 12A expresses data “00”, FIG. 12B expresses data “01”, FIG. 12C expresses data “10”, and FIG. 12D expresses data “11”. The associated wave form d is an associated wave form of a fundamental wave a, the secondary higher harmonic wave component b, and the tertiary higher harmonic wave component c. Examples of FIGS. 12A to 12D are fundamental wave a: amplitude A=1.0, A sin(f₀), secondary higher harmonic wave: amplitude B=0.2, ±B sin(2f₀), tertiary higher harmonic wave: amplitude C=0.2, and ±C sin(2f₀).

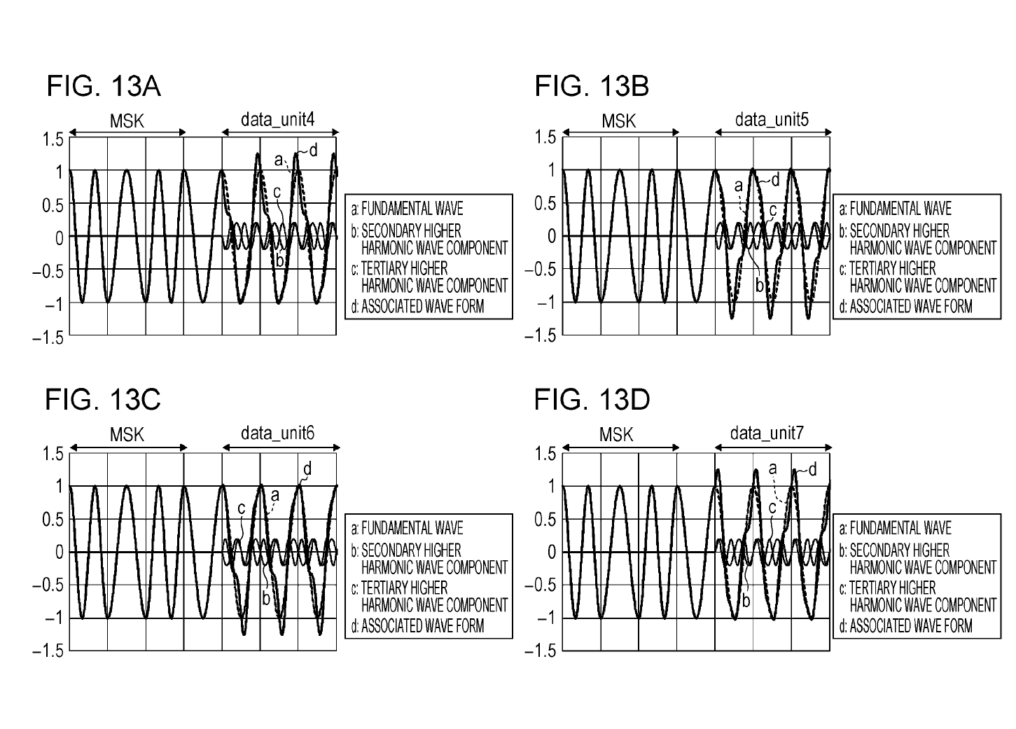

FIGS. 13A to 13D, for example, correspond to the first example or the second example of the recording and the reproduction in the optical disc. FIGS. 13A to 13D, for example, correspond to the first example or the second example of the recording and the reproduction in the optical disc. Next to the MSK, the monotone wobble is arranged. In the next section, the wobble of the data unit which has been OFDM modulated, and is illustrated as the associated wave form d is arranged. For example, FIG. 13A expresses the data “00”, FIG. 13B expresses data “01”, FIG. 13C expresses data “10”, and FIG. 13D expresses data “11”. The associated wave form d is the associated wave form of the fundamental wave a, the secondary higher harmonic wave component b, and the tertiary higher harmonic wave component c. Examples of FIGS. 13A to 13D are fundamental wave a: amplitude A=1.0, A cos(f₀), secondary higher harmonic wave: amplitude B=0.2, and ±B sin(2f₀), tertiary higher harmonic wave: amplitude C=0.2, and ±C sin(3f₀).

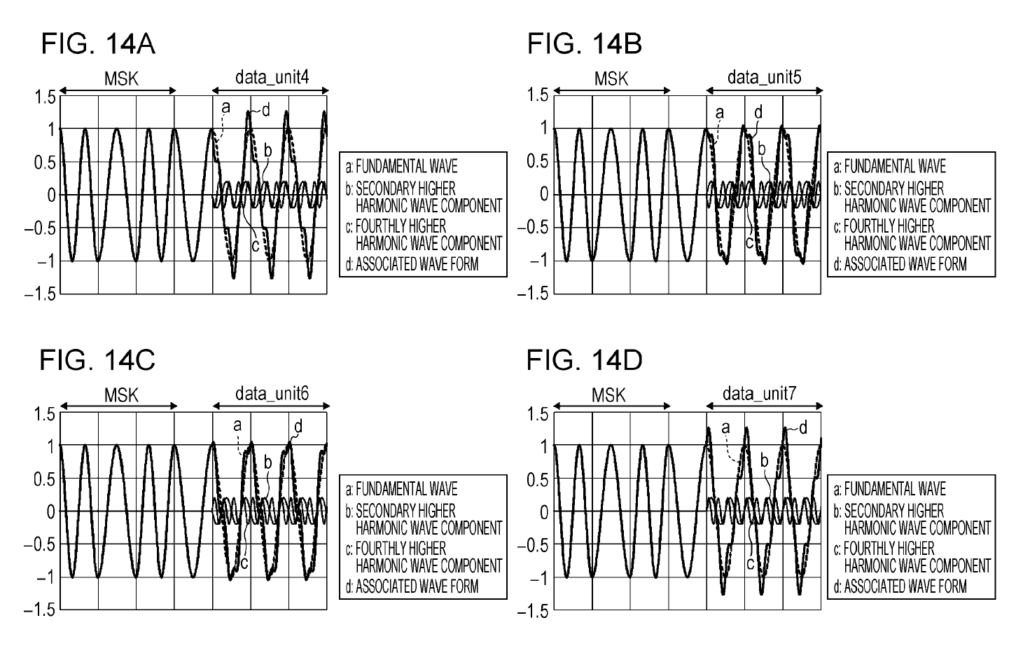

FIGS. 14A to 14D, for example, correspond to the other example of the recording and the reproduction in the optical disc. Next to the MSK, the monotone wobble is arranged. In the next section, the wobble of the data unit which has been OFDM modulated, and is illustrated as the associated wave form d is arranged. For example, FIG. 14A expresses the data “00”, FIG. 14B expresses the data “01”, FIG. 14C expresses the data “10”, and FIG. 14D expresses the data “11”. The associated wave form d is the associated wave form of the fundamental wave a, the secondary higher harmonic wave component b, and the fourthly higher harmonic wave component c. Examples of FIGS. 14A to 14D are fundamental wave: amplitude A=1.0, A cos(f₀), secondary higher harmonic wave: amplitude B=0.2, and ±B sin(2f₀), fourthly higher harmonic wave: amplitude C =0.2, and ±C sin(4f₀).

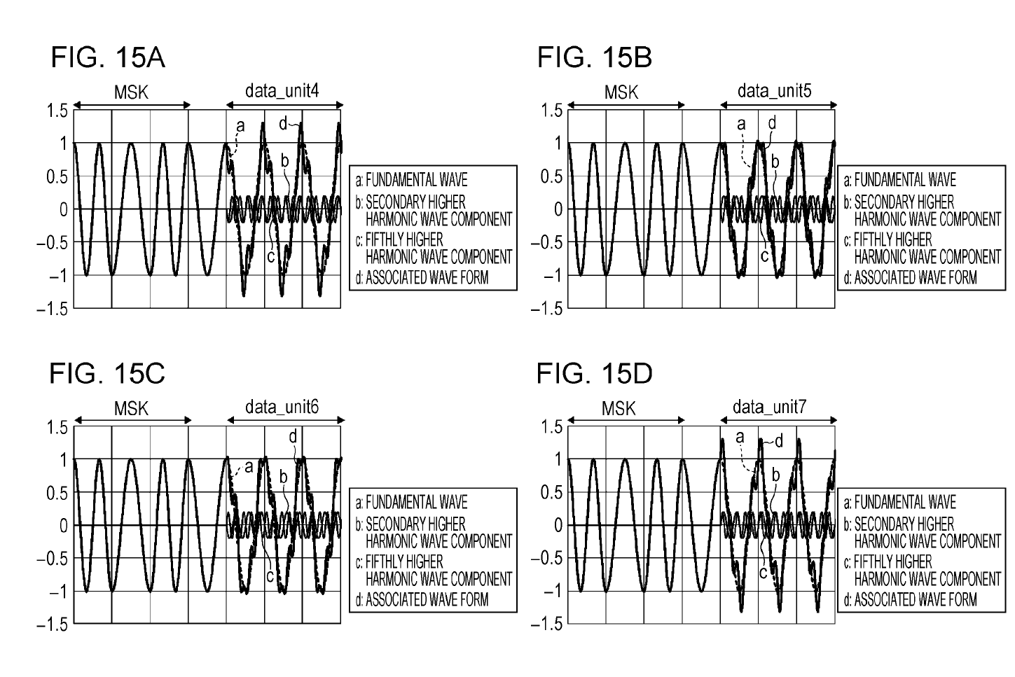

FIGS. 15A to 15D, for example, correspond to the other example of the recording and the reproduction in the optical disc. Next to the MSK, the monotone wobble is arranged. In the next section, the wobble of the data unit which has been OFDM modulated, and is illustrated as the associated wave form d is arranged. For example, FIG. 15A expresses the data “00”, FIG. 15B expresses the data “01”, FIG. 15C expresses the data “10”, and FIG. 15D expresses the data “11”. The associated wave form d is the associated wave form of the fundamental wave a, the secondary higher harmonic wave component b, and the fourthly higher harmonic wave component c. Examples of FIGS. 15A to 15D are fundamental wave: amplitude A=1.0, A cos(f₀), secondary higher harmonic wave: amplitude B=0.2, and ±B sin(2f₀), fifthly higher harmonic wave: amplitude C=0.2, and ±C sin(5f₀).

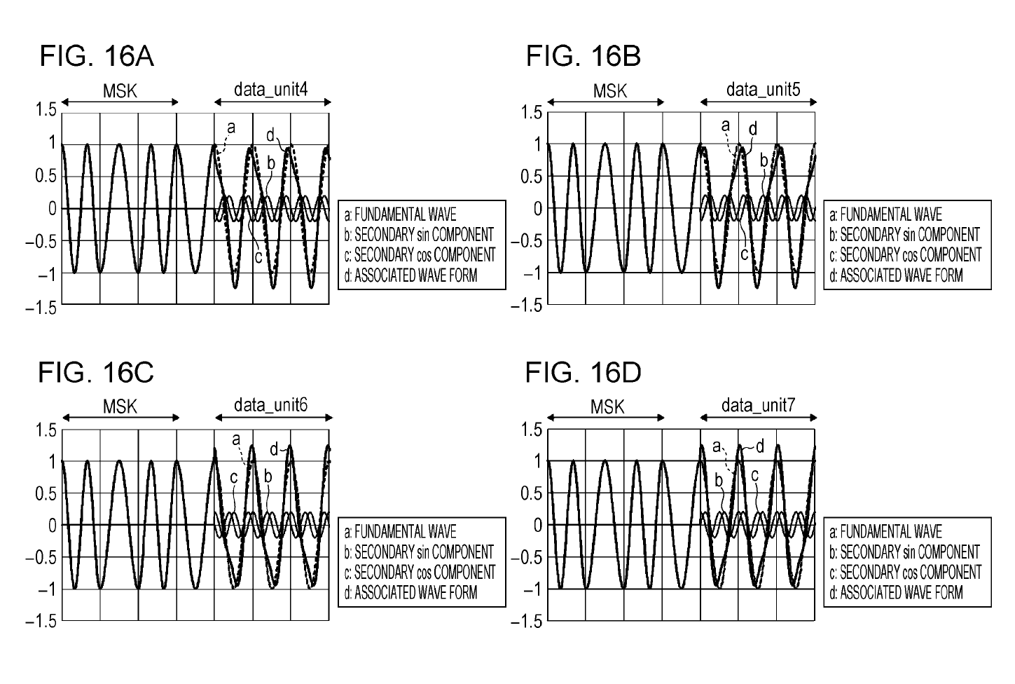

FIGS. 16A to 16D, for example, correspond to the third example of the recording and the reproduction in the optical disc. Next to the MSK, the monotone wobble is arranged. In the next section, the wobble of the data unit which has been OFDM modulated, and is illustrated as the associated wave form d is arranged. For example, FIG. 16A expresses the data “00”, FIG. 16B expresses the data “01”, FIG. 16C expresses the data “10”, and FIG. 16D expresses the data “11”. The associated wave form d is the associated wave form of the fundamental wave a, the secondary higher harmonic wave component b, and the secondary higher harmonic wave component c. Examples of FIGS. 16A to 16D are fundamental wave: amplitude A=1.0, A cos(f₀), secondary higher harmonic wave: amplitude B=0.2, and ±B sin(2f₀), secondary higher harmonic wave: amplitude C=0.2, and ±cos(2f₀).

Further, in the examples of FIGS. 16A to 16D, an uncontinuous wobble has occurred, but in a time of recording, it is possible to eliminate the discontinuous wobble by filtering the wobble signal in a method of LPF (Low-pass filter). In this case, a wobble wave form is changed due to an influence of the LPF, and in a time of reproduction, a detected signal is slightly degraded, but there is no problem when a section of integration is sufficiently long. Further, a degradation of the wave form in a signal detection area may be prevented by placing a beginning position of a data area ahead of a MSK side.

### 3. Second Embodiment

### Address Recording Apparatus

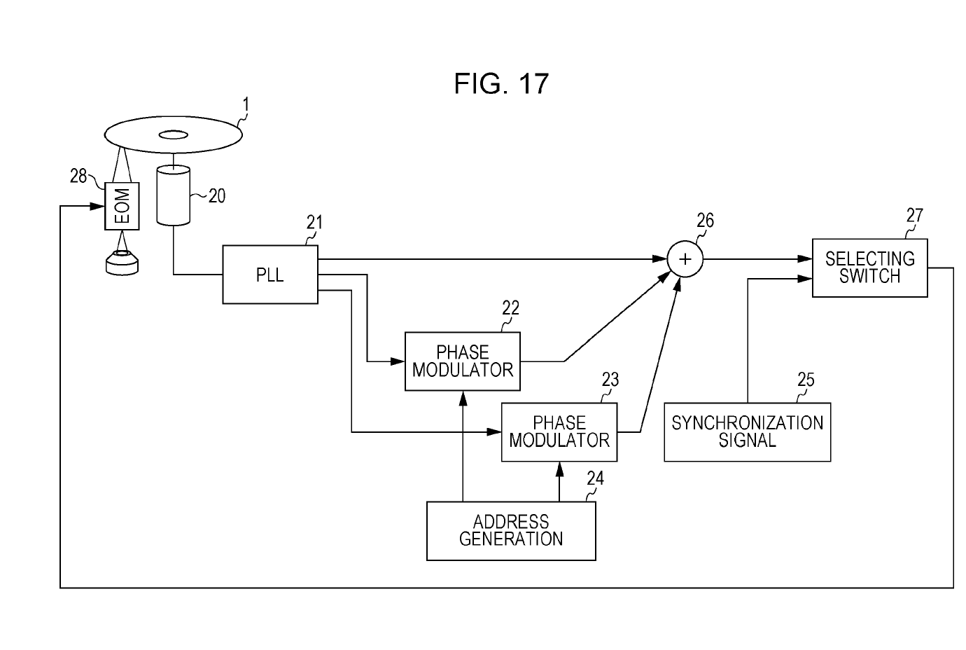

A configuration example of an address recording apparatus according to a second embodiment of the present technology will be described. FIG. 17 is a block diagram illustrating the configuration example of the address recording apparatus which forms a wobble groove. In FIG. 17, a disk 1 is mounted on a turntable, and rotated at the constant angular velocity by a spindle motor 20. The spindle motor 20 is controlled by a spindle servo.

A pulse generator (not shown) is mounted on a bottom portion of the spindle motor 20, and generates a rotation synchronization signal according to a rotation of the spindle motor 20. The rotation synchronization signal is formed to generate a sine wave of 2100 pulses, for example, when the spindle motor 20 rotates 1 round.

A PLL (Phase Locked Loop) 21 inputs the rotation synchronization signal output from the spindle motor 20, and outputs a wobble fundamental wave, a first higher harmonic wave, and a second higher harmonic wave. The wobble fundamental wave is, for example, the sine wave (sin wave) of the non-modulation, the first higher harmonic wave is, for example, the secondary higher harmonic wave of 2 times the wobble fundamental wave frequency, and the second higher harmonic wave is, for example, the tertiary higher harmonic wave of 3 times the wobble fundamental wave frequency. Particularly, the first higher harmonic wave is, for example, the secondary higher harmonic wave of 2 times the wobble fundamental wave frequency, and the second higher harmonic wave is, for example, the tertiary higher harmonic wave of 3 times the wobble fundamental wave frequency. Further, the wobble fundamental wave may be a cosine wave (cos wave) of the non-modulation. In addition, the first higher harmonic wave, and the second higher harmonic wave may be a higher harmonic wave of integer times the fundamental wave other than the secondary higher harmonic wave, and the tertiary higher harmonic wave, and may be the higher harmonic wave such as the fourthly higher harmonic wave or the fifthly higher harmonic wave.

A phase modulator 21 modulates the first higher harmonic wave based on address information generated the address generating unit 24. For example, based on the address information, the first higher harmonic wave is modulated in the phase modulator 21, and the second higher harmonic wave is modulated in a phase modulator 22.

An adder 26 adds an output from the PLL 21, an output from the phase modulator 21, and an output from the phase modulator 22, and outputs the associated wave where the fundamental wave, a modulated secondary higher harmonic wave, and a modulated tertiary higher harmonic wave are superposed. The associated wave is added to a synchronization signal (MSK and the like) output from a synchronization signal unit 25, and is output to an EOM (electro-optic modulator) 27 by appropriately changing a selector switch 27.

On the other hand, one side of the disc 1 or an optical pickup which is irradiated by the laser beam for recording is transported to the radial direction of the disc by a slide transporting motor, and an exposure is performed in a desired pattern to the disc 1, it is possible to expose a latent image of a groove pattern in a data recording area in a predetermined track pitch to the disc (resist layer). The laser beam for recording is generated from a laser light source. The light source may be used arbitrarily, it is preferable that the source emit the laser beam of a short wavelength.

The laser beam emitted from the laser light source enters the EOM 27. The EOM 27 supplies a voltage fitting a shape desired to do wobbling by changing a proceeding direction of the laser beam corresponding to the voltage input, and emits an exposure beam to the radial direction. The laser beam biased by an EOM 6 irradiates the disc 1, and the latent image is formed corresponding to the groove provided with the wobble.

### Manufacturing of Optical Disc

Following the above mentioned process, for example, the following process is performed. Further, the following process is an example, and is not to be limited to an example described hereinafter. Developing and processing is performed to the resist layer on the disc 1. As an example, the resist layer coated to the disc 1 is a positive-type resist, and it is possible to obtain a disc where the groove has been patterning processed since a part where the latent image has been formed by a resist light is dissolved by developing.

Next, it is possible to obtain a stamper by extracting a metal such as nickel by plating on the disc, peeling off the metal, and performing a trimming. A disc substrate is manufactured by providing the stamper in a cavity of an injection molding apparatus, and injecting a resin in the cavity. And after having cooled an injection molded disc substrate, a reflective film is formed by forming a metallic thin film such as an aluminum alloy and silver on a pit surface side with a sputtering apparatus.

Next, coating evenly is performed in a spin coating method by dropping an ultraviolet curing resin as an adhesive agent on the disc substrate where the reflection layer has been formed. Thereafter, after holding a coated surface of the ultraviolet curing resin on the disc substrate and a polycarbonate film for forming a cover layer (thickness 0.1 mm) so as to face each other, laminating is performed. Further, laminating the polycarbonate film is performed in a vacuum. The reason is that an occurrence of a reading error may be prevented by preventing a wrinkle or a gap on laminated surfaces of the disc substrate and the polycarbonate film.

Next, the ultraviolet curing resin is cured by irradiating an ultraviolet to the disc where the polycarbonate film has been laminated, and thus, the disc substrate and the polycarbonate film are laminated. Further, a hard coated layer is manufactured by dropping a hard coat agent of an ultraviolet curing type to the disc where the polycarbonate film has been laminated, applying an even coating thereto in the spin coating method, and again irradiating the ultraviolet so that the disc is cured. Thus, a writable optical disc is completed.

### 4. Third Embodiment

### Disc Reproducing Apparatus

Regarding a disc reproducing apparatus according to a fourth embodiment of the present technology, a reproduction of the address will be mainly described. As shown in FIGS. 7A and 7B, the data is recorded to an optical disc 10 where the groove address and land address are recorded, and the data is reproduced from the optical disc 10.

The optical disc 10 is rotated in the constant angular velocity by a spindle motor 32. That is, the optical disc 10 is rotated in the CAV method. A zone CAV method may be used, and the CLV method may be used. A driving signal from a laser driving unit 34 is supplied to an optical head 33, the laser beam whose strength has been modulated corresponding to recording data 35 irradiates from the optical head 33 to the optical disc 10, and the data is recorded in a predetermined position of the optical disc 10 determined based on the reproduced address information.

The reading laser beam from the optical head 33 is irradiated to the optical disc 10, the reflected light is detected by a photodetector in the optical head 33, and the reproduced signal is detected by a signal detection unit 36. A reproduced signal 37, a servo error signal 38 such as a focus error signal and a tracking error signal, and the wobble signal 39 are read from the signal detection unit 36. The wobble signal 39 is an output signal of a photodetector where a photo detection element is divided into 2 parts to the direction of the track. For example, a summation signal of two photodetectors is read as the wobble signal 39. The wobble signal 39 is changed corresponding to the wobble wave form. In a case where wobbles of the both sides of a track are in the same phase, a level of the wobble signal 39 is maximized, and in a case where the wobbles of the both sides are in a reverse phase from each other, the level of the wobble signal 39 is minimized.

An error signal 38 is supplied to a servo circuit 40. The rotation of the spindle motor 32 is controlled in the constant angular velocity by the servo circuit 40, and a focus and a tracking of the optical head 33 are controlled.

The wobble signal 39 detected by the signal detection unit 36 is supplied to an A/D convertor 41, and is modulated to a digital signal by the A/D convertor 41. An output signal of the A/D convertor 41 is supplied to a digital PLL 42, an OFDM decoding unit 43, and the MSK decoding unit 44. The reproduced signal and a synchronized clock are output from the PLL 42. The clock is set to a basis of a timing for processing in a time of reproducing.

A digital output of the wobble signal is decoded by the MSK decoding unit 44 and the OFDM decoding unit 43, and is supplied to the ADIP decoder 45.

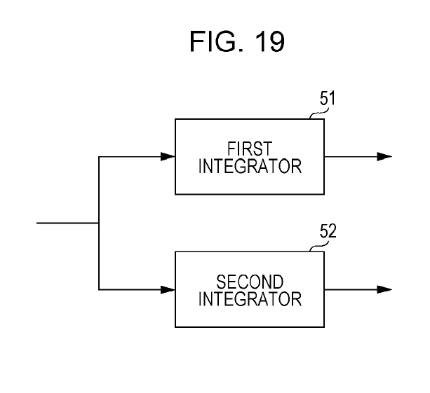

FIG. 19 illustrates an example of the OFDM decoding unit 43. Further, here, a configuration example of a case where the first example of the recording and the reproducing is applied is illustrated. For example, in a case where the first example of the recording and the reproducing is applied, in a first integrator 51, an integrated value is obtained by multiplying a signal of the frequency of 2 times the fundamental wave to the wobble signal, and integrating the preceding result during 1 cycle of the fundamental wave that is an unit recording section, and is output to the ADIP decoder 45. In a second integrator 52, an integrated value is obtained by multiplying a signal of the frequency of 3 times the fundamental wave to the wobble signal, and integrating the preceding result during 1 cycle of the fundamental wave that is a unit recording section, and is output to the ADIP decoder 45.

The ADIP decoder 45 decodes the address data and the like recorded in every ADIP word, and performs an error correction. A decoded address data is output from the ADIP decoder 45.

For example, in a case of applying the first example of the recording and the reproducing mentioned above, in a case of scanning the groove track, the address information of the both sides of abutting lands which interpose the groove is restored, and the address data which is defined as the groove interposed by the abutting lands is read as the output. In a case of scanning the land track, the address information of the land is restored, and the address data of the land is read as the output.

For example, in a case of applying the second example and the third example of the recording and the reproducing, in a case of scanning the groove track, the address information of the groove is restored, and in a case of scanning the land track where the address data of the groove is read as the output, the address information of the both sides of abutting grooves which interpose the land is restored, and the address data which is defined as the land interposed by the abutting grooves is read as the output.

Heretofore, a detailed description has been given regarding an embodiment of the present technology, but embodiments are not limited to each embodiment described above, and various modifications may be applied based on a technological idea of the present technology. For example, a configuration, a method, a process, a form, a material, a numerical value, and the like enumerated in the above mentioned embodiment are only examples, and the configuration, the method, the process, the form, the material, the numerical value, and the like different therefrom may be used according to a purpose. In addition, the configuration, the method, the process, the form, the material, the numerical value, and the like of the embodiment may be combined mutually insofar as it does not deviate from a gist of the present technology.

In an embodiment of the present technology, it is possible to increase a track density by recording the land/groove. It is possible to record the address information without reducing a user data area. It is possible to restore the address information in a time of reproducing the land as well as in a time of reproducing the groove. It is possible to reproduce the clock in a stable and continuous manner in a time of reproducing the land as well as in a time of reproducing the groove. It is possible to easily perform a mastering regarding the disc that records an address for the land/groove by an exposure apparatus of one beam.

The present technology may adopt the following configuration.

[1] An optical information recording medium on which recording address information is performed by a CAV or a zone CAV system, wherein a groove wobbling continuously is formed in advance to record the information to the groove and a land abutting the groove, wherein the address information is recorded by a wobble where a plurality of modulated waves which have been modulated by the address information are multiply formed, wherein the modulated wave is a higher harmonic wave whose frequency is a fundamental wave of the fundamental frequency of the wobble, or an integer times the fundamental frequency of the wobble, wherein one modulated wave is modulated by the address information of one land of the abutting lands which interpose the groove, and wherein the other modulated wave is modulated by the address information of the other land of the abutting lands which interpose the groove.

[2] The optical information recording medium according to [1], wherein the address information of one abutting land is restored by decoding the one modulated wave, wherein the address information of the other abutting land is restored by decoding the other modulated wave, and wherein the address information of the groove is reproduced as the groove interposed by the one and the other land whose address information has been restored.

[3] The optical information recording medium according to any one of [1] and [2], wherein the address information of the land is reproduced by decoding the one or the other modulated wave and restoring the address information of the land.

[4] The optical information recording medium according to any one of [1] to [3], wherein a land track is numbered in an order facing from a center to an outer circumference, wherein one land is a land of the even number, and wherein the other land is a land of the odd number.

[5] The optical information recording medium according to any one of [1] to [4], wherein one and the other modulated wave are higher harmonic waves whose frequencies are different from each other.

[6] The optical information recording medium according to any one of [1] to [4], wherein the one modulated wave is a sin wave, and the other modulated wave is a cos wave that has the same frequency as the one modulated wave.

[7] An optical information recording medium on which recording address information is performed by a CAV or a zone CAV system, wherein the groove wobbling continuously is formed in advance to record the information to the groove and a land abutting the groove, wherein the address information is recorded by the wobble where a plurality of modulated waves which have been modulated by the address information are multiply formed, wherein the modulated wave is a higher harmonic wave whose frequency is a fundamental wave of the fundamental frequency of the wobble, or an integer times the fundamental frequency of the wobble, and wherein the one modulated wave is modulated by the address information of any one groove of the abutting grooves which interpose the land, and the other modulated wave are modulated by the address information of the other groove of the abutting grooves which interpose the land.

[8] The optical information recording medium according to [7], wherein the address information of the one groove is restored by decoding the one modulated wave, wherein the address information of the other groove is restored by decoding the other modulated wave, and wherein the address information of the land is reproduced as the land interposed by one and the other groove whose address information has been restored.

[9] The optical information recording medium according to any one of [7] and [8], wherein the address information of the groove is reproduced by decoding the one or the other modulated wave and restoring the address information of the groove.

[10] The optical information recording medium according to any one of [7] to [9], wherein a groove track is numbered in an order facing from a center to an outer circumference, wherein the one groove is a groove of the even number, and wherein the other groove is a groove of the odd number.

[11] The optical information recording medium according to any one of [7] to [10], wherein the one and the other modulated wave are higher harmonic waves whose frequencies are different from each other.

[12] The optical information recording medium according to any one of [7] to [10], wherein the one modulated wave is a sin wave, and the other modulated wave is cos wave that has the same frequency as the one modulated wave.

[13] A reproducing apparatus including: a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and a decoding unit that decodes a plurality of the modulated waves extracted from the wobble signal, wherein in the decoding unit, the address information of one abutting land which interposes the groove is restored by decoding one modulated wave, and the address information of the other abutting land which interpose the groove is restored by decoding the other modulated wave, and wherein the address information of the groove is reproduced as the groove interposed by one and the other land whose address information has been restored.

[14] The reproducing apparatus according to [13], wherein the address information of the land is reproduced by decoding the one or the other modulated wave and restoring the address information of the land.

[15] The reproducing apparatus according to any one of [13] and [14], wherein the decoding unit includes: a first decoding unit in which the one modulated wave is decoded; and a second decoding unit in which the other modulated wave is decoded.

[16] A reproducing apparatus including: a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and a decoding unit that decodes a plurality of the modulated waves extracted from the wobble signal, wherein in the decoding unit, the address information of one abutting groove which interposes the land is restored by decoding one modulated wave, the address information of the other abutting groove which interposes the land is restored by decoding the other modulated wave, and wherein the address information of the land is reproduced as the land interposed by one and the other groove whose address information has been restored.

[17] The reproducing apparatus according to [16], wherein the address information of the groove is reproduced by decoding the one or the other modulated wave and restoring the address information of the groove.

[18] The reproducing apparatus according to any one of [16] and [17], wherein the modulation unit includes: a first decoding unit in which the one modulated wave is decoded; and a second decoding unit in which the other modulated wave is decoded.

The present disclosure contains subject matter related to that disclosed in Japanese Priority Patent Application JP 2012-126724 filed in the Japan Patent Office on Jun. 4, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical information recording medium on which recording address information is performed by a CAV or a zone CAV system,
wherein a groove wobbling continuously is formed in advance to record the information to the groove and a land abutting the groove,
wherein the address information is recorded by a wobble where a plurality of modulated waves which have been modulated by the address information are multiply formed,
wherein the modulated wave is a higher harmonic wave whose frequency is a fundamental wave of the fundamental frequency of the wobble, or an integer times the fundamental frequency of the wobble,
wherein one modulated wave is modulated by the address information of one land of the abutting lands which interpose the groove, and
wherein the other modulated wave is modulated by the address information of the other land of the abutting lands which interpose the groove.

2. The optical information recording medium according to claim 1,
wherein the address information of one abutting land is restored by decoding the one modulated wave,
wherein the address information of the other abutting land is restored by decoding the other modulated wave, and
wherein the address information of the groove is reproduced as the groove interposed by the one and the other land whose address information has been restored.

3. The optical information recording medium according to claim 2,
wherein the address information of the land is reproduced by decoding the one or the other modulated wave and restoring the address information of the land.

4. The optical information recording medium according to claim 1,
wherein a land track is numbered in an order facing from a center to an outer circumference,
wherein one land is a land of the even number, and
wherein the other land is a land of the odd number.

5. The optical information recording medium according to claim 1,
wherein one and the other modulated wave are higher harmonic waves whose frequencies are different from each other.

6. The optical information recording medium according to claim 1,
wherein the one modulated wave is a sin wave, and the other modulated wave is a cos wave that has the same frequency as the one modulated wave.

7. An optical information recording medium on which recording address information is performed by a CAV or a zone CAV system,
wherein the groove wobbling continuously is formed in advance to record the information to the groove and a land abutting the groove,
wherein the address information is recorded by the wobble where a plurality of modulated waves which have been modulated by the address information are multiply formed,
wherein the modulated wave is a higher harmonic wave whose frequency is a fundamental wave of the fundamental frequency of the wobble, or an integer times the fundamental frequency of the wobble, and
wherein the one modulated wave is modulated by the address information of any one groove of the abutting grooves which interpose the land, and the other modulated wave are modulated by the address information of the other groove of the abutting grooves which interpose the land.

8. The optical information recording medium according to claim 7,
wherein the address information of the one groove is restored by decoding the one modulated wave,
wherein the address information of the other groove is restored by decoding the other modulated wave, and
wherein the address information of the land is reproduced as the land interposed by one and the other groove whose address information has been restored.

9. The optical information recording medium according to claim 8,
wherein the address information of the groove is reproduced by decoding the one or the other modulated wave and restoring the address information of the groove.

10. The optical information recording medium according to claim 7,
wherein a groove track is numbered in an order facing from a center to an outer circumference,
wherein the one groove is a groove of the even number, and
wherein the other groove is a groove of the odd number.

11. The optical information recording medium according to claim 7,
wherein the one and the other modulated wave are higher harmonic waves whose frequencies are different from each other.

12. The optical information recording medium according to claim 7,
wherein the one modulated wave is a sin wave, and the other modulated wave is cos wave that has the same frequency as the one modulated wave.

13. A reproducing apparatus comprising:
a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and
a decoding unit that decodes a plurality of the modulated waves extracted from the wobble signal,
wherein in the decoding unit, the address information of one abutting land which interposes the groove is restored by decoding one modulated wave, and the address information of the other abutting land which interpose the groove is restored by decoding the other modulated wave, and
wherein the address information of the groove is reproduced as the groove interposed by one and the other land whose address information has been restored.

14. The reproducing apparatus according to claim 13,
wherein the address information of the land is reproduced by decoding the one or the other modulated wave and restoring the address information of the land.

15. The reproducing apparatus according to claim 13,
wherein the decoding unit includes:
a first decoding unit in which the one modulated wave is decoded; and
a second decoding unit in which the other modulated wave is decoded.

16. A reproducing apparatus comprising:
a reading unit that reads a wobble signal from an optical information recording medium on which address information is recorded by a wobble where a plurality of modulated waves which have been modulated by the address information are multiply formed, the modulated wave being a higher harmonic wave whose frequency is a fundamental wave of the fundamental frequency of the wobble, or an integer times the fundamental frequency of the wobble; and
a decoding unit that decodes a plurality of the modulated waves extracted from the wobble signal,
wherein in the decoding unit, the address information of one abutting groove which interposes the land is restored by decoding one modulated wave, the address information of the other abutting groove which interposes the land is restored by decoding the other modulated wave, and
wherein the address information of the land is reproduced as the land interposed by one and the other groove whose address information has been restored.

17. The reproducing apparatus according to claim 16,
wherein the address information of the groove is reproduced by decoding the one or the other modulated wave and restoring the address information of the groove.

18. The reproducing apparatus according to claim 16, wherein the modulation unit includes:
a first decoding unit in which the one modulated wave is decoded; and
a second decoding unit in which the other modulated wave is decoded.
